(19) United States
(12) Patent Application Publication
(10) Pub. No.: US 2026/0199955 A1
(43) Pub. Date: Jul. 16, 2026

(54) AUTOMATED LOW VOLUME PRODUCTION SYSTEM

(71) Applicant: HIROTEC AMERICA, Auburn Hills, MI (US)

(72) Inventors: Gary T. Krus, Rochester Hills, MI (US); Jim B. Toeniskoetter, Oak Park, MI (US); Kyusang Yun, West Bloomfield, MI (US)

(21) Appl. No.: 19/020,425

(22) Filed: Jan. 14, 2025

(51) Int. Cl. B21D 43/12; B66F 9/06

(52) U.S. Cl. CPC B21D 43/12; B66F 9/063

(57) ABSTRACT

A method includes conveying a part from a first indexing conveyor to a press, operating the press with a first die attached thereto to perform a first die operation, creating a first part shape. The first part shape is conveyed from the press to a first rack on a second indexing conveyor. The first die is removed from the press. A second die is transported to a die exchange unit, conveyed to the press, and attached to the press. The first rack is transported to the first indexing conveyor via a first automated mobile robot. A second rack is transported to the second indexing conveyor via a second automated mobile robot. The first part shape is conveyed from the first rack to the press. The press is operated to perform a second die operation to create a second part shape. The second part shape is conveyed to the second rack.

### TECHNICAL FIELD

The present disclosure relates to systems and methods for the production of stamped parts. More particularly, in embodiments, the present disclosure relates to systems and methods for the automated production of automotive parts using a single press.

### BACKGROUND

Traditional processes for the production of automotive parts use progressive multi-press production lines. Multi-press systems require a significant capital investment and large workspace. Multi-press systems can also have low operational efficiency, with one or more stations or presses being idle during the production of the automotive parts. For example, if an automotive part requires six die operations, the production line would need six sequential presses. However, if another automotive part only requires three die operations, then three of the presses in the production line would be idle. These requirements and inefficiencies may significantly affect the cost-effectiveness of multi-press systems when producing lower volumes of automotive parts. Accordingly, multi-press systems are not well suited to handle lower production volumes of automotive parts.

### SUMMARY

Described herein are methods and systems for the automated production of parts. In an embodiment, a method for the automated production of parts includes conveying a part from a first indexing conveyor to a press. The press is operated with a first die attached thereto to perform a first die operation to create a first part shape. The first part shape is conveyed from the press to a first rack on a second indexing conveyor. A second die is transported to a die exchange unit. The first die is removed from the press and conveying the first die to the die exchange unit. The second die is conveyed from the die exchange unit to the press. The second die is attached to the press. The first rack is transported to the first indexing conveyor via a first automated mobile robot. A second rack is transported to the second indexing conveyor via a second automated mobile robot. The first part shape is conveyed from the first rack on the first indexing conveyor to the press. The press is operated with the second die attached thereto to perform a second die operation on the first part shape to create a second part shape. The second part shape is conveyed from the press to the second rack on the second indexing conveyor.

In an embodiment, a low-volume production system for an automated production of parts includes a plurality of racks for holding parts, a plurality of dies configured to shape the parts, and a press for performing a die operation on the parts, wherein the press is configured to be interchangeably mounted with the plurality of dies. A die exchange unit is adjacent the press and configured for housing at least one of the plurality of dies, and wherein the die exchange unit is configured to convey the at least one of the plurality of dies to the press. A crane is mounted to a rail and configured to translate along the rail and transport the plurality of dies to and from the die exchange unit. A first indexing conveyor is configured to convey the plurality of racks along the first indexing conveyor. A second indexing conveyor is configured to convey the plurality of rack along the second indexing conveyor. A first robot is configured to convey the parts from the plurality of racks on the first indexing conveyor to the press. A second robot is configured to convey the parts from the press to the plurality of racks on the second indexing conveyor. A first automated mobile robot is programmed to: transport the plurality of racks loaded with parts by the second robot from the second indexing conveyor to a rack loading area, and transport the plurality of racks loaded with parts from the rack loading area to the first indexing conveyor. A second automated mobile robot programmed to: transport the plurality of racks without parts to the second indexing conveyor, and transport the plurality of racks loaded with parts by the second robot from the second indexing conveyor to the rack loading area.

In an embodiment, a production system for an automated production of parts includes a plurality of dies arranged in a die field and configured to shape parts, a first production line, and a second production line. The first production line and the second production line both include: a plurality of racks for holding the parts, a press for performing a die operation on the parts, wherein the press is configured to be interchangeably mounted with the plurality of dies, a die exchange unit adjacent the press and configured for housing at least one of the plurality of dies, and wherein the die exchange unit is configured to convey the at least one of the plurality of dies to the press, a first indexing conveyor configured to convey the plurality of racks along the first indexing conveyor, a second indexing conveyor configured to convey the plurality of rack along the second indexing conveyor, a first robot configured to convey the parts from the plurality of racks on the first indexing conveyor to the press, a second robot configured to convey the parts from the press to the plurality of racks on the second indexing conveyor, a first automated mobile robot programmed and configured to transport the plurality of racks loaded with parts from the second indexing conveyor to a respective rack loading area of the first or second production line, and wherein the first automated mobile robot is programmed and configured to transport the plurality of racks loaded with parts from the respective rack loading area of the first or second production line to the first indexing conveyor, and a second automated mobile robot programmed and configured to transport the plurality of rack without parts to the second indexing conveyor, and wherein the second automated mobile robot is programmed and configured to transport the plurality of racks loaded with parts by the second robot from the second indexing conveyor to the respective rack loading area of the first or second production line. A crane is configured to transport the plurality of dies between the die field and the die exchange units of the first production line and the second production line.

### BRIEF DESCRIPTION OF THE DRAWINGS

FIG. 1 is an overhead schematic diagram of a production system, according to an embodiment of the present disclosure;

FIGS. 2-16 illustrates a production process of the production system, according to an embodiment of the present disclosure;

FIG. 17 is an overhead schematic of a production system including a first production line and a second production line that share a plurality of dies, according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

A part as used herein refers to a blank (e.g., a sheet or panel on which no die operations have been performed or is the first part or material on which a first die operation will be performed), a material or panel on which a die operation has been performed (e.g., the material is no longer in an original shape). Nevertheless, for clarity the present disclosure may distinguish between a part and a blank. Conveying as used herein refers to the moving of an object from one location to another, or inserting the objects into, positioning the objects at, or removing the objects from a work cell, machine, or component of a production system, or the like. Conveying may be accomplished by rolling, carrying, grabbing, or releasing the objects, or the like. Transporting as used herein may be used interchangeably with conveying. Attaching as used herein refers to connecting, mounting, or installing, or the like, a tool or device that may be used to perform a task. Automated as used herein refers to a system or process that uses machines and programmed commands to perform tasks or work autonomously with little, some, or no required human intervention or input for each task or operation of the machines. For example, an automated system may include software automation, robotics, robotic process automation, industrial automation, or the like. An automated system or process may include some human intervention to oversee or control a part of the system or process, such as the transportation of dies, or the like.

The following detailed description is merely exemplary in nature and is not intended to limit the invention or the application and uses of the invention. The systems and methods are described herein with respect to the production of automotive parts, such as body panels. However, one of ordinary skill in the art will understand that the systems and methods may also be used for the production of any part or component formed using a press and a die, such as aerospace parts, household appliances (e.g., washing and drying machines), medical appliances or equipment (e.g., respirators and masks), or the like.

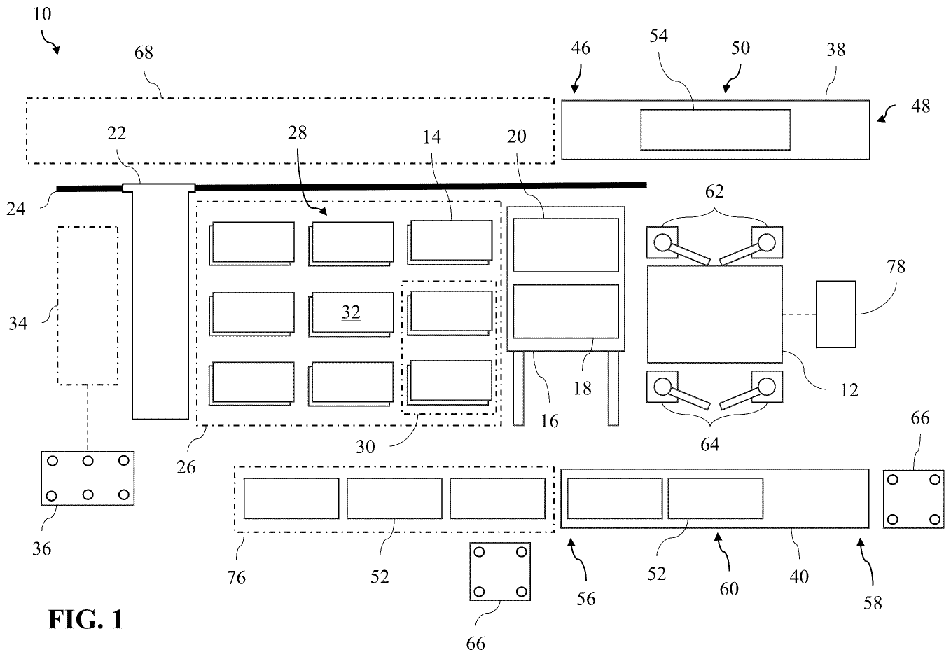

Referring to FIG. 1, in an embodiment, a production system 10 may be configured for the automated production of parts, such as body panels including doors, hoods, trunk lids, fenders, or the like. Other parts include structural components (e.g., a frame, including cross members and chassis components), engine components (e.g., cylinder heads, exhaust manifolds, valve covers, or the like), transmission parts (e.g., gears, clutches, housings), etc.

The production system 10 may include a press 12 and a plurality of dies 14. The press 12 may be a pneumatic press, hydraulic stamping press, servomotor stamping press, or the like. The press 12 is configured to interchangeably receive or be mounted with the plurality of dies 14 for stamping to form or cut the parts (e.g., the plurality of dies 14 may be configured to draw, trim, pierce, flange, bend, stretch, coin, iron, shear, blank, or notch the parts, or the like). The plurality of dies 14 may include an upper die and a lower die and the press 12 may include upper and lower attachment devices for securing and/or mounting the upper die and the lower die to the press 12. For example, the upper die and the lower die may be in a vertically stacked relationship when conveyed to the press 12. The upper attachment devices may be coupled to the upper die (e.g., the upper attachment devices may be hooks or clamps configured to attached to hooks, loops, recess, or the like, of the upper die) such that the upper die can be lifted and separated from the lower die, and a part can be inserted between the upper die and the lower die. The lower attachment devices die may be coupled the lower die such that the lower die does not shift during operation.

A die exchange unit 16 may be located adjacent to a side of the press 12 and may include a first die change station 18 and a second die change station 20, wherein the first die change station 18 and the second die change station 20 are configured to hold, house, or receive at least one of the plurality of dies 14. The die exchange unit 16 may be configured to move or translate vertically such that one of the first die change station 18 or the second die change station 20 is aligned with the press 12 (e.g., aligned vertically, axially, or the like). The die exchange unit 16 may be configured to convey one of the plurality of dies 14 from the aligned first or second die change station 18, 20 onto the press 12 (e.g., install, insert, or the like, the one of the plurality of dies 14 into the press 12 for stamping the parts in a desired manner). The die exchange unit 16 may be configured to remove the one of the plurality of dies 14 from the press 12 and convey (e.g., insert, place, or the like) the one of the plurality of dies 14 into the aligned first or second die change station 18, 20.

In an embodiment, the die exchange unit 16 may include a die-change system comprising a roller bar, a lifter, a chain, a rail, bolster extensions, a clamp, or other push-pull module or system, or the like, or a combination or sub-combination thereof. For example, a clamp at an end of a chain may be coupled to the lower die of the one of the plurality of dies 14 located in the aligned first or second die change station 18, 20 and then actuated to pull the one of the plurality of dies 14 onto the press 12, wherein the upper die is then separated from the lower die by the press 12 and a part can be placed between the upper die and lower die for being operated on by the press 12. Similarly, the upper die may be stacked onto to the lower die and released from the press 12, whereby the clamp couples to the lower die and pushes the one of the plurality of dies 14 from the press 12 to the aligned first or second die change station 18, 20. In some embodiments, the die exchange unit 16 may include a T-table die-change system, or the like.

In an embodiment, a crane 22 may be configured to be mounted to and move or translate along a rail 24. The rail 24 may be connected to a floor (e.g., the rail may be along the floor or may be raised above a floor by a structure connected to the floor). In other words, the crane 22 may be operated off of the floor rather than being mounted on a structure of a building housing the production system 10. In this way the crane 22 and rail 24 may be established, removed, relocated, repaired, or adjusted in an easier manner. The crane 22 may be configured to transport the plurality of dies 14 from the die exchange unit 16 to a die field 26, and vice versa. In doing so, the crane 22 can move laterally along the rail 24 (e.g., left and right in the view shown in the Figures). In an embodiment, the crane 22 is configured to move off of the rail 24 and/or without the rail 24. For example, the crane 22 may be “free-range” and include wheels, track, or the like, for moving along the floor. In some embodiments, the crane 22 can be automated and/or operated manually by an operator.

The die field 26 comprises the plurality of dies 14 and may be adjacent the die exchange unit 16 and aligned with the rail 24 and/or the press 12. The plurality of dies 14 may be arranged in rows and columns (e.g., four rows and three columns, or the like) and may be stacked on top of each other or in a stacked relationship (e.g., a two high stack, or the like) to form a stack 28. The stack 28 may include a hanger or storage rack system wherein the plurality of dies 14 may be stored on different levels of the hanger. For example, one of the plurality of dies 14 may be stored on a level below or above another one of the plurality of dies 14 with a common stack 28. The crane 22 may be configured to transport the plurality of dies 14 from the common stack 28. When transporting one of the plurality of dies 14 from the common stack 28, the crane 22 may expose another one of the plurality of dies 14 underneath the one of the plurality of dies 14 being transported. In some embodiments, the crane 22 may be configured to transport the plurality of dies 14 regardless of their position within the stack 28 (e.g., the crane 22 may remove and transport one of the plurality of dies 14 from a bottom of the stack 28, or the like).

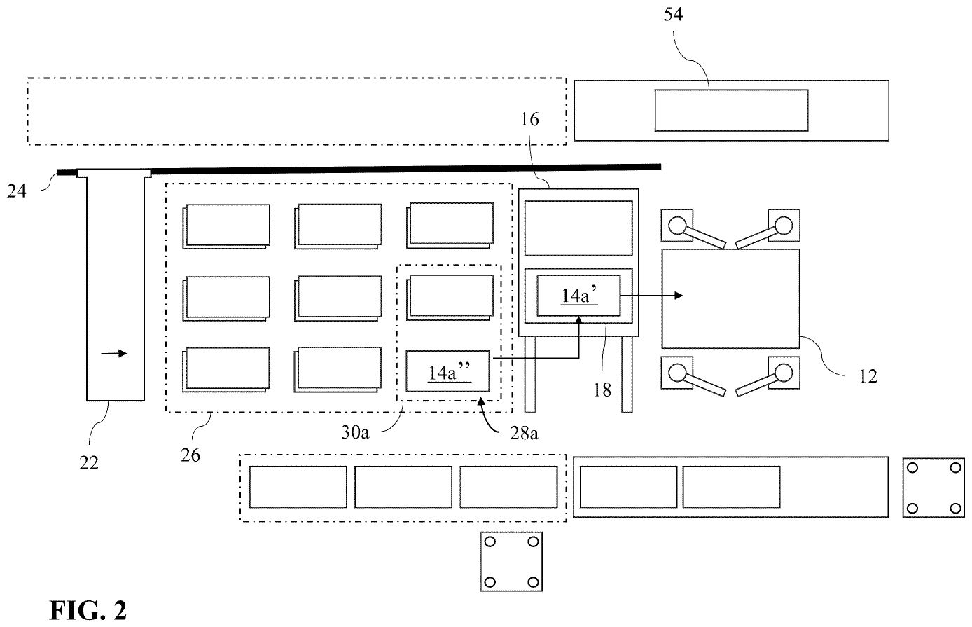

The plurality of dies 14 may also be arranged in or form a group 30 or a plurality of groups 30 including at least one stack 28, wherein the plurality of dies 14 are stacked according to an order of operation of the production system 10, the part, or the like, or a combination or sub-combination thereof. For example, as shown in FIG. 2, a first group 30a may include a first stack 28a and a second stack 28b. The first stack 28a may include a first die 14a′ for drawing stacked on top of a second die 14a″ for trimming and/or piercing. The second stack 28b may include a third die 14b′ for trimming and/or piercing stacked on top of a fourth die 14b″ for trimming, piercing, or flanging. In this way, the crane 22 may sequentially transport the first die 14a′, the second die 14a″, the third die 14b′, and the fourth die 14″ to and from the die exchange unit 16 so that the production system 10 may operate using only one press 12 to perform all die operations of the stamping process for the parts.

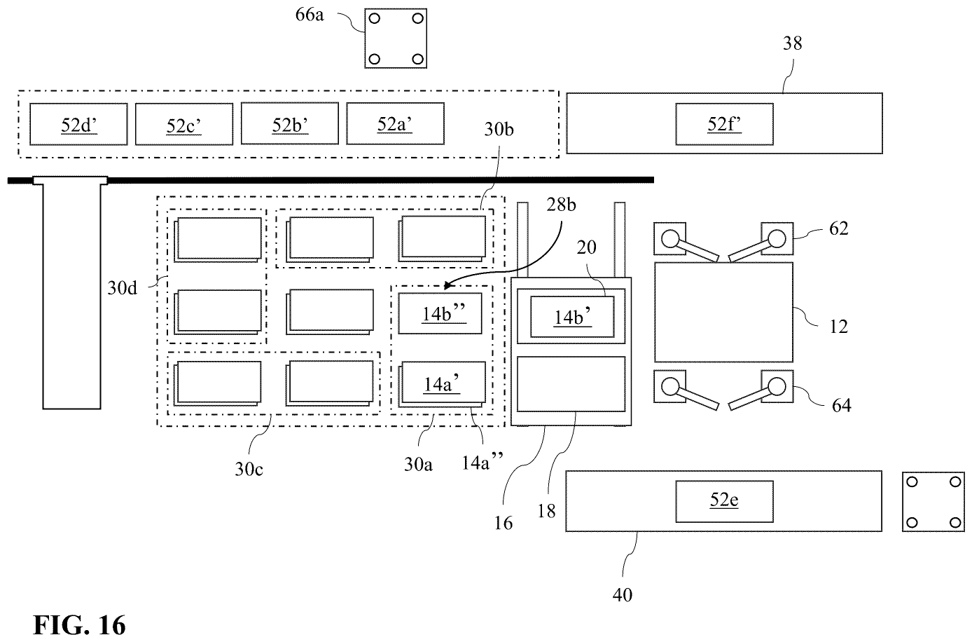

In an embodiment, the plurality of groups 30 may include a second group 30b, a third group 30c, and a fourth group 30d (as shown in FIG. 16). For example, the first group 30a may be configured for producing outer door panels, the second group 30b may be configured for producing inner door panels, and the third group 30c may be configured for producing window frames. The fourth group 30d may be configured for producing certain low volume parts or panels. Accordingly, the press 12 may be interchangeably outfitted with the plurality of dies 14 of the first, second, third, and fourth groups 30a, 30b, 30c, 30d to produce different parts rather than using a progressive press line featuring multiple presses that may require a larger footprint than the production system 10 and are idle when not producing their designated parts. In some embodiments, the die field 26 includes a temporary stack 32. The temporary stack 32 may be part of one of the plurality of groups 30, may include at least one die 14 to supplement one of the plurality of groups 30, may be an empty spot for temporarily storing at least one of the plurality of dies 14 (e.g., for rearrangement of the plurality of dies 14 within the die field 26 or one of the stacks 28, for preparing the at least one of the plurality of dies 14 for maintenance), or the like, or a combination or sub-combination thereof.

The production system 10 may include a die maintenance area 34 for maintenance, repair, replacement, or the like, of the plurality of dies 14. A die transfer cart 36 may be configured to convey the plurality of dies 14 to and from the die maintenance area 34. In some embodiments the crane 22 may be configured and programmed to transport the plurality of dies to and from the die maintenance area 34. The die maintenance area 34 may be located adjacent to the die field 26 and spaced apart from or distal to the die exchange unit 16.

In an embodiment, the press 12 may be positioned between a first indexing conveyor 38 and a second indexing conveyor 40 (i.e., the first indexing conveyor 38 may be positioned adjacent a front side 42 of the press 12 and the second indexing conveyor 40 may be positioned adjacent a back side 44 of the press 12). The first indexing conveyor 38 may have a first side 46, a second side 48 opposite the first side 46, and a press section 50 between the first side 46 and the second side 48. The press section 50 may be aligned with the front side 42 of the press 12. The first indexing conveyor 38 may be configured for conveying a parts rack 52 (e.g., a pallet or the like) and a blanks rack 54 (e.g., blanks loaded onto a rack or the like) to the press section 50. For example, a parts rack 52 holding parts or a blanks rack 54 holding blanks may be loaded on the first side 46 of the first indexing conveyor 38 and conveyed by the first indexing conveyor 38 to the press section 50. In some embodiments, the parts rack 52 and blanks rack 54 may be conveyed from the press section 50 to the second side 48 (e.g., when the parts rack 52 is empty or devoid of parts, or the like). The second indexing conveyor 40 may have a first side 56, a second side 58, and a stamped section 60 between the first side 56 and the second side 58. The stamped section 60 may be aligned with the back side 44 of the press 12. The second indexing conveyor 40 may be configured for conveying the parts rack 52 to the stamped section 60. For example, an empty parts rack 52 may be loaded on to the first side 56 of the second indexing conveyor 40 and conveyed by the second indexing conveyor 40 to the stamped section 60. In some embodiments, the parts rack 52 and blanks rack 54 may be conveyed from the stamped section 60 to the second side 58 (e.g., when the parts rack 52 is full or contains a select number of parts, or the like).

A first robot 62 may be positioned between the first indexing conveyor 38 and the press and may be configured for conveying parts from the parts rack 52 or blanks from the blanks rack 54 to the press 12. The first robot 62 may be configured for conveying parts or blanks to the press 12 when the part rack 52 or blanks rack 54 are positioned in the press section 50 of the first indexing conveyor 38 to the press 12. A second robot 64 may be positioned between the second indexing conveyor 40 and the press 12 and may be configured for conveying stamped parts to the parts rack 52 in the stamped section 60 of the second indexing conveyor 40. The first robot 62 and the second robot 64 may include flexible servo- configurable end effectors having vacuum cups or grippers for loading and unloading the blanks and/or parts regardless of the geometrical shape of the parts. In some embodiments, the first and second robots 62, 64 may include mechanical, magnetic, or other servo grippers, or the like. The first and second robots 62, 64 may include sensors for determining the presence or absence of the parts, the force or torque being applied by the first and second robots 62, 64 to the parts, or the like. The sensors may be proximity sensors, force sensors, cameras, light sensors, magnetic sensors, range sensors, or the like. The end effectors may be robotic force compliance end effectors, use active compliant technology, or be passive end effectors, or the like.

In an embodiment, the press 12 and the plurality of dies 14 may be configured to receive and stamp the blanks into two parts (e.g., a left part and a right part) or two blanks into respective parts (or a left part and a right part). Similarly, the press 12 and the plurality of dies 14 may be configured to stamp receive and stamp two parts contemporaneously. The first and second robots 62, 64 may be configured to load or unload the two parts. For example, the first and second robots 62, 64 may include a left robot and a right robot (e.g., positioned on a left and right side of the press 12) for loading or unloading the respective left part and right part.

In some embodiments, the first and/or second robots 62, 64 may be configured to place one of the plurality of dies 14 from the aligned first or second die change stations 18, 20 onto the press 12 and may be configured to remove the one of the plurality of dies 14 from the press 12 and insert the one of the plurality of dies 14 into the aligned first or second die change station 18, 20.

In an embodiment, the production system 10 may include a plurality of parts racks 52 for increasing the volume of production, efficiency, and flexibility of the production system 10. For example, the plurality of parts racks 52 may include a first, second, third, fourth, and firth parts rack 52a, 52b, 52c, 52d, 52e.

In an embodiment, the production system 10 may include an automated mobile robot (AMR) 66, automated ground vehicle (AGV), remote push cart, or the like. The AMR 66 may be programmed and configured for automatically transporting the plurality of racks 52. For example, the AMR 66 may automatically transport the plurality of racks 52 or blanks rack 54 to and from the first and second indexing conveyors 38, 40 and may remove or load the plurality of racks 52 or blanks rack 54 from and on to the first and second indexing conveyors 38, 40.

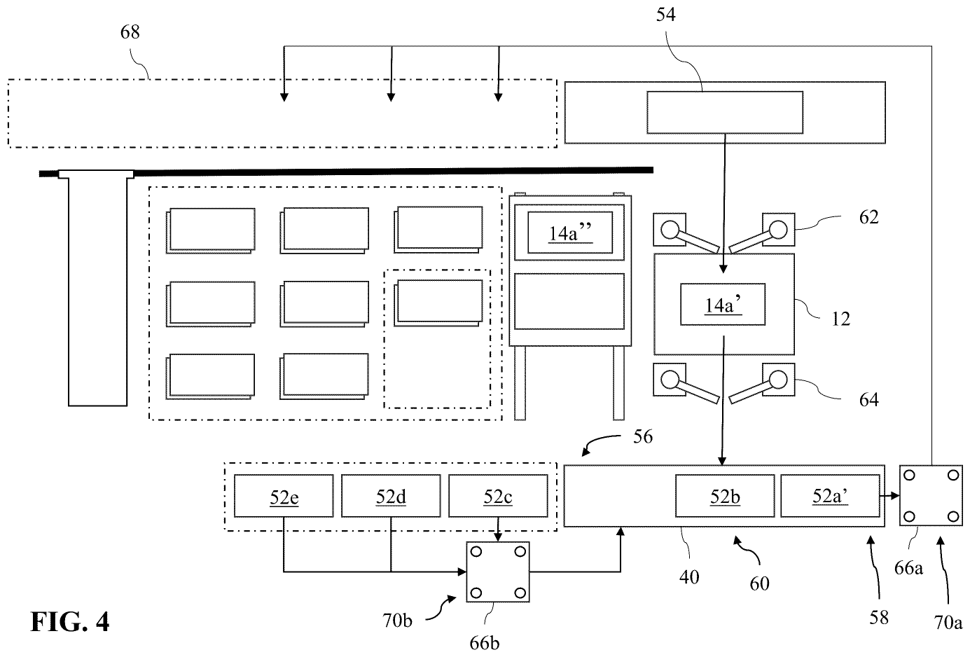

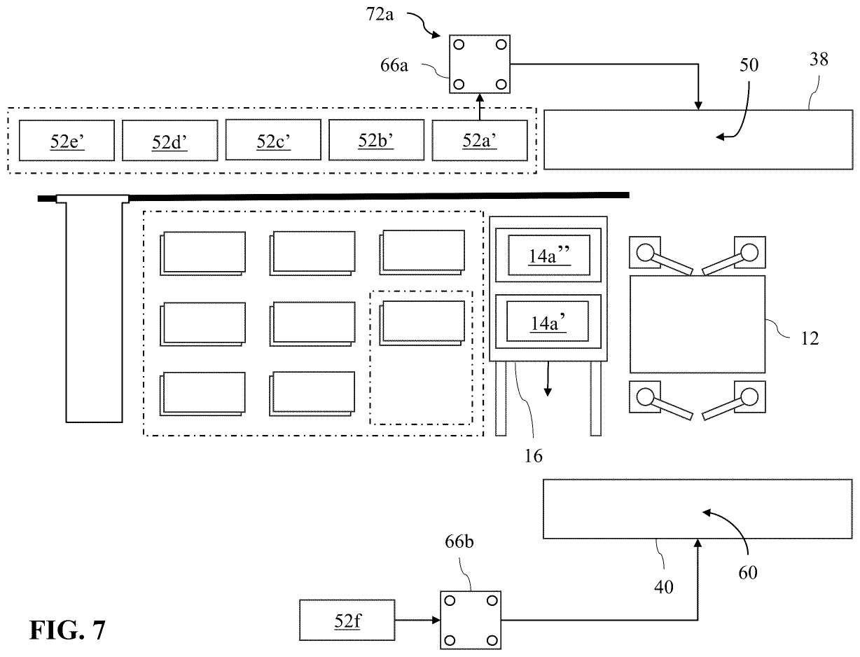

In some embodiments, the production system 10 may include a first AMR 66a and a second AMR 66b. The first AMR 66a may be programmed and configured for removing a parts rack 52 holding stamped parts from the second side 58 of the second indexing conveyor 40 and transporting the parts rack 52 to a rack loading area 68. As shown in FIG. 4, before or after transporting the parts rack 52 to the rack loading area 68, the first AMR 66a may be programmed to move to a first operation position 70a to be ready for transporting another parts rack 52 to the rack loading area 68. The operating position 70a may be adjacent the second side 58 of the second indexing conveyor 40, or the like. The first AMR 66a may further be programmed and configured for transporting the parts rack 52 holding stamped parts from the rack loading area 68 to the first side 46 of the first indexing conveyor 38 and loading the parts rack 52 on to the first indexing conveyor 38. As shown in FIGS. 7-14, the first AMR 66a may be programmed to move to a second operating position 72a before or after transporting the parts rack 52 to the first indexing conveyor 38. The second operation position 72a may be adjacent the first side 46 of the first indexing conveyor 38 or one of the plurality of parts racks 52 to be transported to the first indexing conveyor 38, or the like.

The rack loading area 68 may be adjacent or in relative close proximity to the first indexing conveyor 38. In some embodiments, the rack loading area 68 is spaced apart from the first indexing conveyor 38 due to a layout of the production system 10, to avoid interfering with the production of other equipment, for safety reasons, or the like.

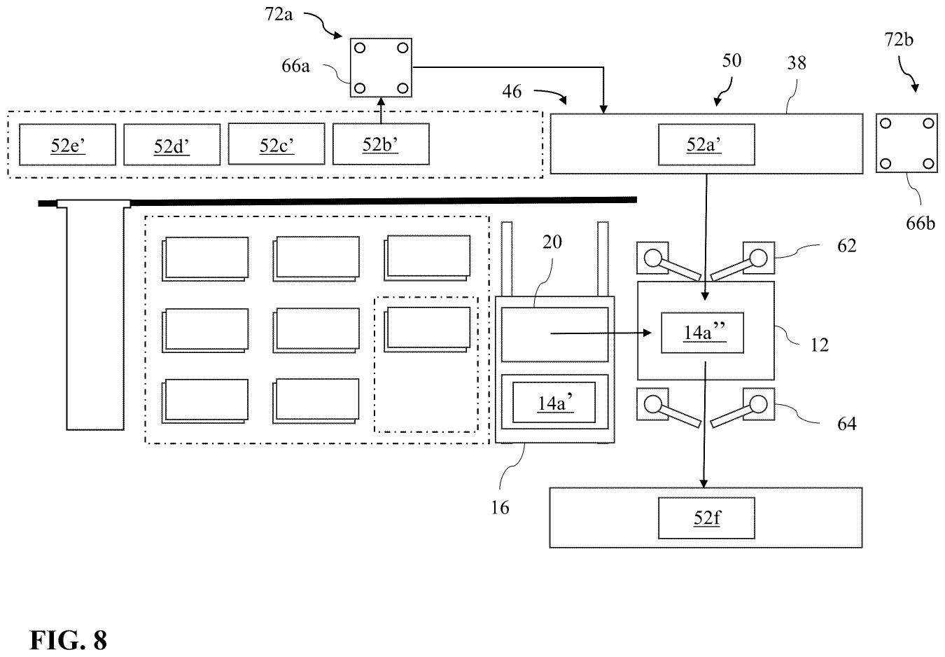

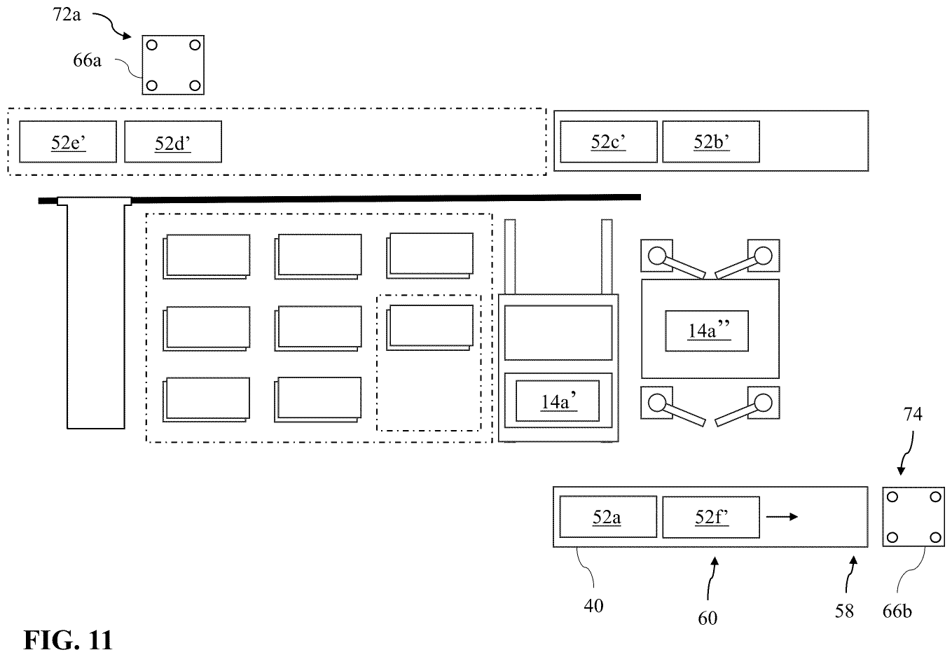

The second AMR 66b may be programmed and configured for automatically transporting an empty parts rack 52 from a rack storage area 76 to the first side 56 of the second indexing conveyor 40 and loading the empty parts rack 52 on to the second indexing conveyor 40. As shown in FIG. 4, before or after transporting the empty parts rack 52 to the second indexing conveyor 40, the second AMR 66b may be programmed to return to a first operation position 70b to be ready for transporting another empty parts rack 52 to the second indexing conveyor 40. The operating position 70b may be adjacent the rack storage area 76, or the like. The second AMR 66b may further be programmed and configured for removing an empty parts rack 52 from the second side 48 of the first indexing conveyor 38 and transporting the empty parts rack 52 to the rack storage area 76 or the first side 56 of the second indexing conveyor 40. As shown in FIGS. 8, 10, and 13, the second AMR 66b may be programmed to move to a second operating position 72b before or after transporting the empty parts rack 52. The second operating position 72b may be adjacent the second side 48 of the first indexing conveyor 38, or the like. As shown in FIGS. 11, 12, and 14, the second AMR 66b may be programmed to move to a third operating position 74 for removing and transporting a parts rack 52 from the second indexing conveyor 40 to the rack loading area 68. The third operating position 74 may be adjacent the second side 58 of the second indexing conveyor 40. In some embodiments, the third operating position 74 is the first operating position 70a of the first AMR 66a such that the second AMR 66b operates similar to the first AMR 66a by transporting the parts rack 52 from the second indexing conveyor 40 to the rack loading area 68. Generally, the second AMR 66b performs this function during a second, subsequent, or non-initial die operation.

It may be said that several of the devices disclosed herein (e.g., the first AMR 66a, the second AMR 66b, etc.) may be “programmed” to perform various functions. It should be understood that “programmed” means, for example, that the device includes processor hardware (shared, dedicated, or group) that executes code and memory hardware (shared, dedicated, or group) that stores code executed by the processor hardware. Execution of the code commands a controller to perform a desired action. In one example, the controller may include a processor, memory, and non-volatile storage. The processor may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. The memory may include a single memory device or a plurality of memory devices including, but not limited to, random access memory (“RAM”), volatile memory, non-volatile memory, static random-access memory (“SRAM”), dynamic random-access memory (“DRAM”), flash memory, cache memory, or any other device capable of storing information. The non-volatile storage may include one or more persistent data storage devices such as a hard drive, optical drive, tape drive, non-volatile solid-state device, or any other device capable of persistently storing information. The processor may be configured to read into memory and execute computer-executable instructions embodying one or more software programs residing in the non-volatile storage. Programs residing in the non-volatile storage may include or be part of an operating system or an application, and may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL. The computer-executable instructions of the programs may be configured, upon execution by the processor, to cause transport a plurality of racks loaded with parts from an indexing conveyor to a rack loading area, for example.

In some embodiments, the second AMR 66b may be programmed and configured for removing the blanks rack 54 from the first indexing conveyor 38 after all the blanks have been conveyed to the press 12 by the first robot 62, and transporting the empty blanks rack 54 to a storage area.

The rack storage area 76 may be adjacent or in relative close proximity to the second indexing conveyor 40. In some embodiments, the rack storage area 76 may be spaced apart from the second indexing conveyor 40 due to a layout of the production system 10, to avoid interfering with the production of other equipment, for safety reasons, or the like.

In some embodiments, the first AMR 66a and the second AMR 66b may be programmed for performing some or all of each other's functions.

In an embodiment, the first and second indexing conveyors 38, 40 may be configured for receiving the parts rack 52 from the AMR 66 (e.g., the first indexing conveyor 38 may configured for receiving the parts rack 52 from the first AMR 66a such that the parts rack 52 may be loaded on to the first indexing conveyor 38). In an embodiment, the first and second indexing conveyors 38, 40 may be configured for transporting the parts rack 52 to the AMR 66 (e.g., the first indexing conveyor 38 may be configured for transporting the empty parts rack 52 on to the second AMR 66b).

In an embodiment, the production system 10 may include a scrap collector 78 configured to collect pieces of scrap created by the press 12 stamping the blanks or parts. The press 12 and/or the plurality of dies 14 may be configured to allow the pieces of scrap to flow through a bottom of the press 12 or the plurality of dies 14 and be conveyed to the scrap collector 78. In some embodiments, the AMR 66 may be programmed and configured for transporting bins to and from the scrap collector 78 (e.g., the AMR 66 may remove and transport a bin that is full with scrap pieces to a collection area and/or may transport and insert an empty bin to the scrap collector 78).

FIGS. 2-16 illustrate sequential operations of the production system 10 in an automated manner according to an embodiment of the present disclosure. The arrows shown in FIGS. 2-16 generally indicate movement of certain elements of the production system 10. The order of operations are exemplary and may be adjusted according to embodiments of the present disclosure.

As shown in FIG. 2, according to an embodiment, the first group 30a includes the first stack 28a, wherein the first die 14a′ is positioned above the second die 14a″. The first die 14a′ is transported from the first stack 28a to the second die change station 20 of the die exchange unit 16 by the crane 22, thereby exposing the second die 14a″. The first die 14a′ is then transported from the second die change station 20 to the press 12, wherein the first die 14a′ is installed (mounted, attached, or the like) to the press 12 for performing a first die operation on the blanks of the blanks rack 54. As previously mentioned the first die 14a′ may be configured for drawing, such that the first die operation forms the blanks by drawing.

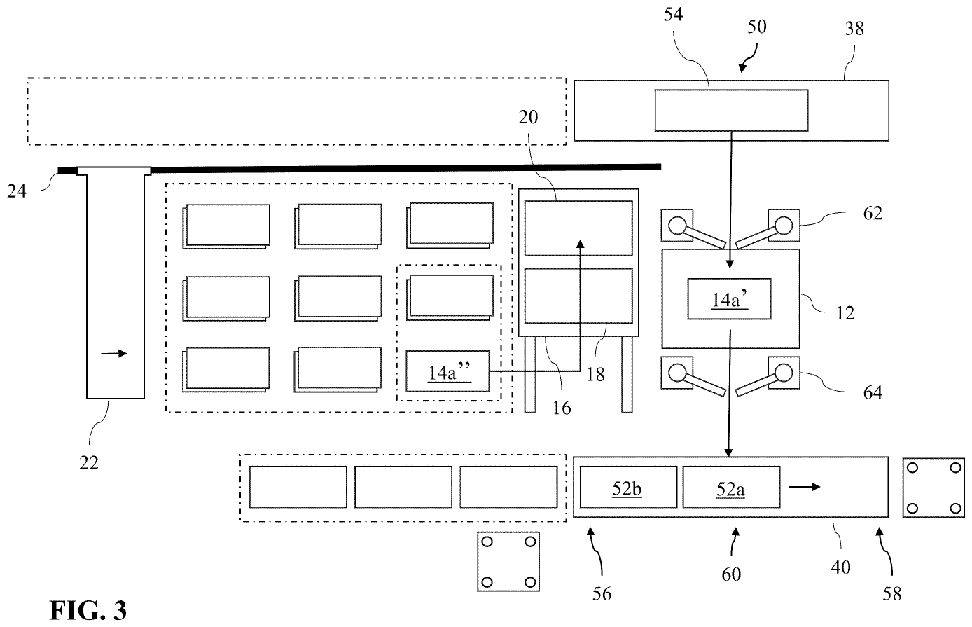

As shown in FIG. 3, the first robot 62 automatically conveys the blanks from blanks rack 54 positioned in the press section 50 of the first indexing conveyor 38 to the press 12, wherein the press 12 mounted with the first die 14a′ performs the first die operation and draws the blanks to create the parts in a first form. The second robot 64 then conveys the first form parts form the press 12 to the first parts rack 52a positioned on the second indexing conveyor 40 in the stamped section 60 until the first parts rack 52a is fully loaded (e.g., the first parts rack 52a cannot hold any more parts or has reached a designated number of parts, or the like). When the first parts rack 52a is fully loaded, the first parts rack 52a′ is automatically conveyed from the stamped section 60 to the second side 58 by the second indexing conveyor 40. The second parts rack 52b is empty and is automatically conveyed from the first side 56 to the stamped section 60 by the second indexing conveyor 40. The conveyance of the full first parts rack 52a′ and the second parts rack 52b by the second indexing conveyor 40 may be contemporaneous.

Meanwhile, while the press 12 is stamping the blanks with the first die 14a′, the crane 22 transports the second die 14a″ to the first die change station 18. For simplicity the second die 14a″ is shown being transported to the first die change station 18 in FIG. 3, however, the second die 14a″ may be transported to the first die change station 18 at any point before or after all of the blanks have been stamped by the press 12.

As shown in FIG. 4, the first robot 62 continues automatically conveying the blanks from the blanks rack 54 to the press 12 and the second robot 64 begins conveying the first form parts from the press 12 to the second parts rack 52b. The full parts rack 52a′ is automatically transported from the second indexing conveyor 40 to the rack loading area 68 by the first AMR 66a, after which the first AMR 66a returns to the first operating position 70a adjacent the second side 58 of the second indexing conveyor 40. Before, during, or after the full parts rack 52a′ is transported to the rack loading area 68, the second AMR 66b automatically transports the third parts rack 52c from the rack storage area 76 to the first side 56 of the second indexing conveyor 40 and the returns to the first operating position 70b adjacent the rack storage area 76. A full second parts rack 52b′ is eventually conveyed to the second side 58 by the second indexing conveyor 40 to be automatically transported to the rack loading area 68 by the first AMR 66a and the third parts rack 52c is conveyed to the stamped section 60, wherein the second robot 64 conveys the first form parts to the third parts rack 52c. As discussed above, the second AMR 66b will automatically transport the fourth parts rack 52d and the fifth parts rack 52e to the first side 56 of the second indexing conveyor 40 and the first AMR 66a will automatically transport a full third parts rack 52c′ from the second side 58 of the second indexing conveyor 40 to the rack loading area 68. The transportation order of the plurality of racks 52 by the first ARM 66a and second AMR 66b may be programmed based on a desired transportation order, transportation speed of the plurality of racks 52 by the first ARM 66a and second AMR 66b to and from the first and second indexing conveyors 38, 40, safety requirements, or the like. The described transportation order described herein is merely exemplarily.

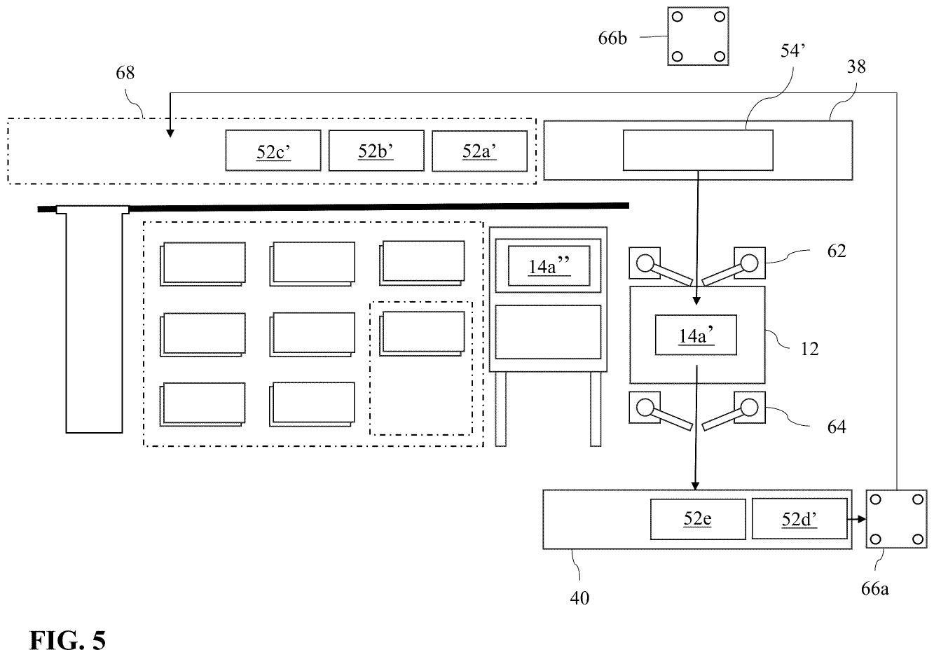

As shown in FIG. 5, a full fourth parts rack 52d′ is automatically transported by the first AMR 66a to the rack loading area 68 and arranged in a row with the full first, second, and third parts racks 52a′, 52b′, 52c′. The first robot 62 continues automatically conveying the blanks from the blanks rack 54 to the press 12 and the second robot 64 is conveying the first form parts from the press 12 to the fifth parts rack 52e. The second AMR 66b may move to a position in relative proximity to the first indexing conveyor 38 to be ready for transport an empty blanks rack 54′ to a storage area after all the blanks have been conveyed to the press 12 by the first robot 62.

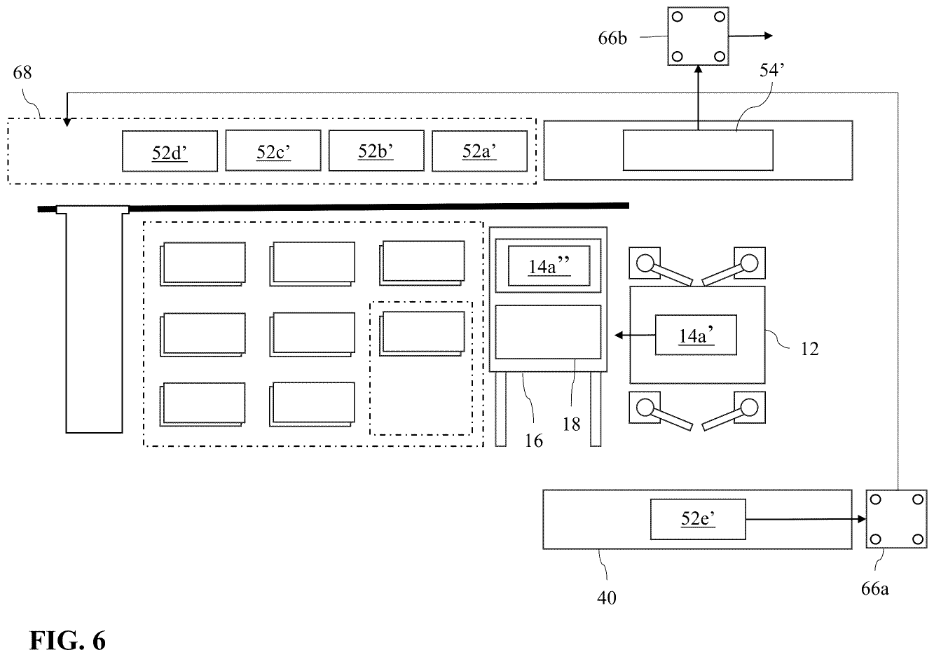

As shown in FIG. 6, the second AMR 66b transports the empty blanks rack 54′ to a storage area after all the blanks have been conveyed to the press 12 by the first robot 62. The first AMR 66a transports a full fifth parts rack 55e′ to the rack loading area 68, after which the first AMR 66a may move to the second operating position 72a adjacent to or in close proximity to the full first parts rack 55a′. The first die 14a′ is automatically removed from the press 12 and transported to the second die exchange station 20.

As shown in FIG. 7, the second AMR 66b automatically transports an empty sixth parts rack 52f (e.g., a spare parts rack 52f) to the stamping section 60 of the second indexing conveyor 40. The sixth parts rack 52f may be located within the rack storage area 76 or elsewhere within a factory, warehouse, or the like. The second AMR 66b may then move to the second operating position 72b adjacent the second side 48 of the first indexing conveyor 38. The first AMR 66a transports the full first parts rack 52a′ to the press section 50 of the first indexing conveyor 38. The first AMR 66a then moves to the second operating position 72a adjacent the full second parts rack 52b′. The die exchange unit 16 translates vertically to align the second die 14a″ and/or the first die change station 18 with the press 12 and position the second die 14a″ to be conveyed to the press 12.

As shown in FIG. 8, the second die 14a″ is conveyed from the first die change station 18 to the press 12 by the die exchange unit 16, the first robot 62, or the second robot 64. The second die 14a″ is attached to the press 12 for performing a second die operation on the first form parts (e.g., trimming or piercing). The first robot 62 automatically conveys the first form parts from the full first rack 52a′ to the press 12, wherein the press 12 mounted with the second die 14a″ performs the second die operation on the first form parts of the full first rack 52a′ to create second form parts. The second form parts are conveyed from the press 12 to the sixth parts rack 52f by the second robot 64. The first AMR 66a transports the full second parts rack 52 to the first side 46 of the indexing conveyor 38 and moves to the second operating position 72a adjacent the full third parts rack 52c′.

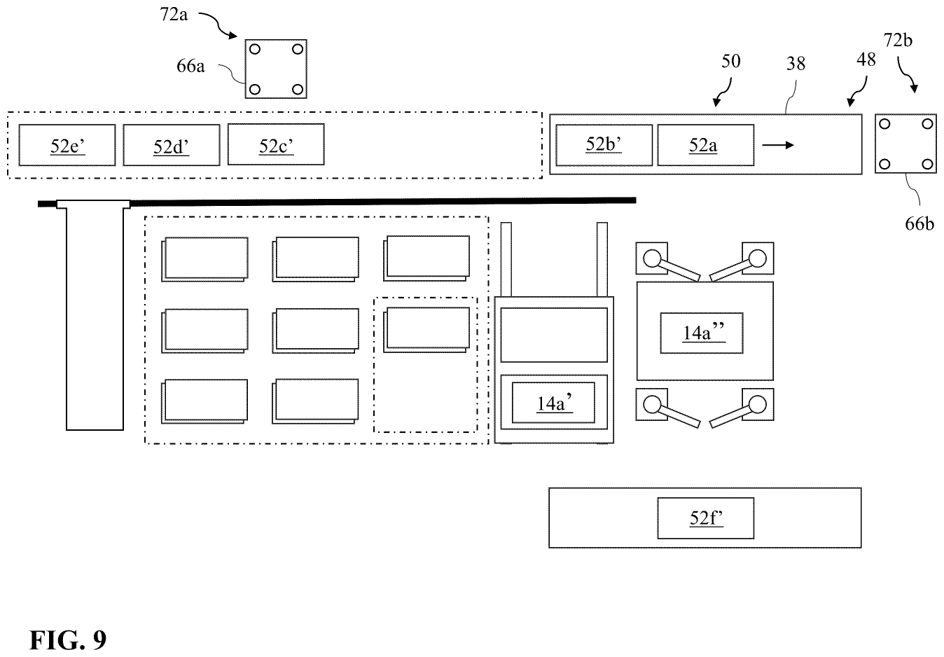

As shown in FIG. 9, the first parts rack 52a is conveyed to the second side 48 of the first indexing conveyor 38 once all of the first form parts are removed from the first parts rack 52a (i.e., the full parts rack 52a′ is now empty). The full second parts rack 52b′ is conveyed to the press section 50 of the first indexing conveyor 38. A full sixth parts rack 52f′ is fully loaded with second form parts.

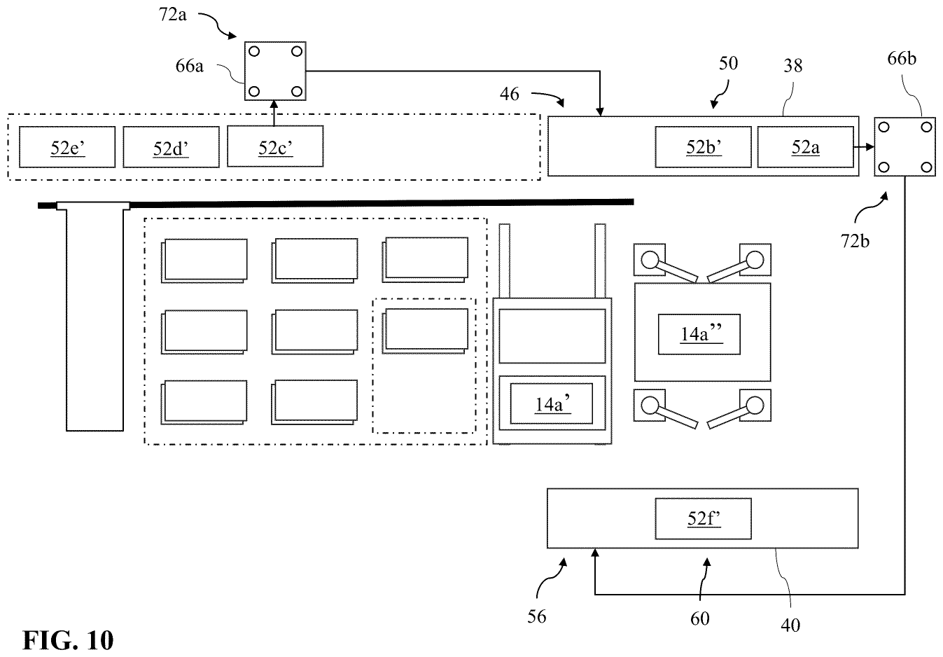

As shown in FIG. 10, the second AMR 66b transports the first parts rack 52a to the first side 56 of the second indexing conveyor 40 and moves to the first operating position 70b adjacent the second indexing conveyor 40. The first AMR 66a transports the full third parts rack 52c′ to the first side 46 of the first indexing conveyor 38 and moves the second operating position 72a adjacent the full fourth parts rack 52d′.

As shown in FIG. 11, the full sixth parts rack 52f′ is conveyed to the second side 58 of the second indexing conveyor 40 and the first parts rack 52a is conveyed to the stamping section 60.

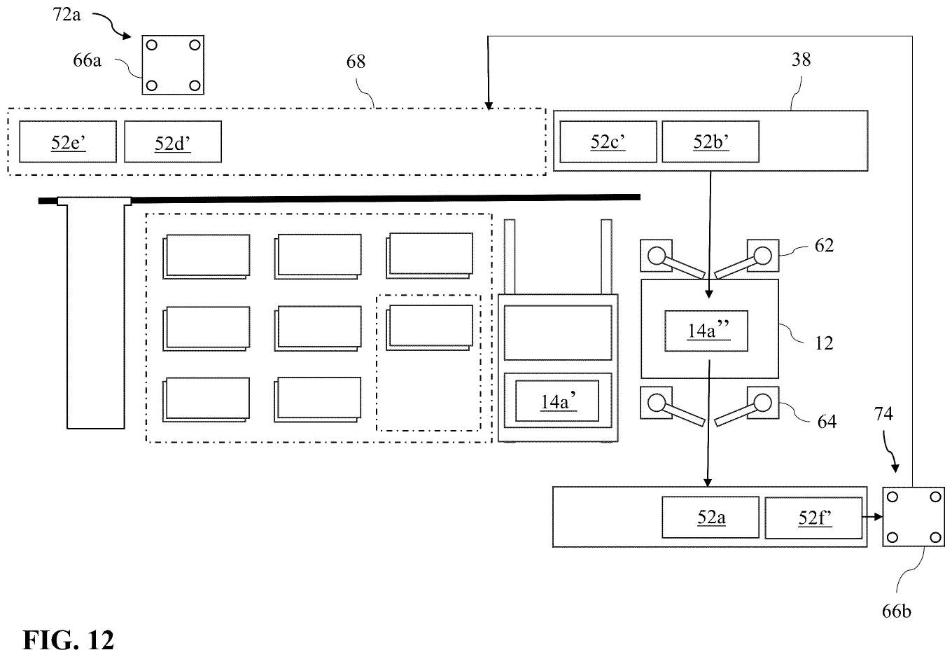

As shown in FIG. 12, the second AMR 66b transports the full sixth parts rack 52f′ to the rack loading area 68 and moves to the second operating position 72b adjacent the second side 48 of the first indexing conveyor 38. The first robot 62 conveys the second form parts from the full second parts rack 52b′ to the press 12, wherein the press 12 mounted with the second die 14a″ performs the second die operation to create second form parts from the first form parts of the full second parts rack 52b′. The second form parts are conveyed by the second robot 64 to the first parts rack 52a.

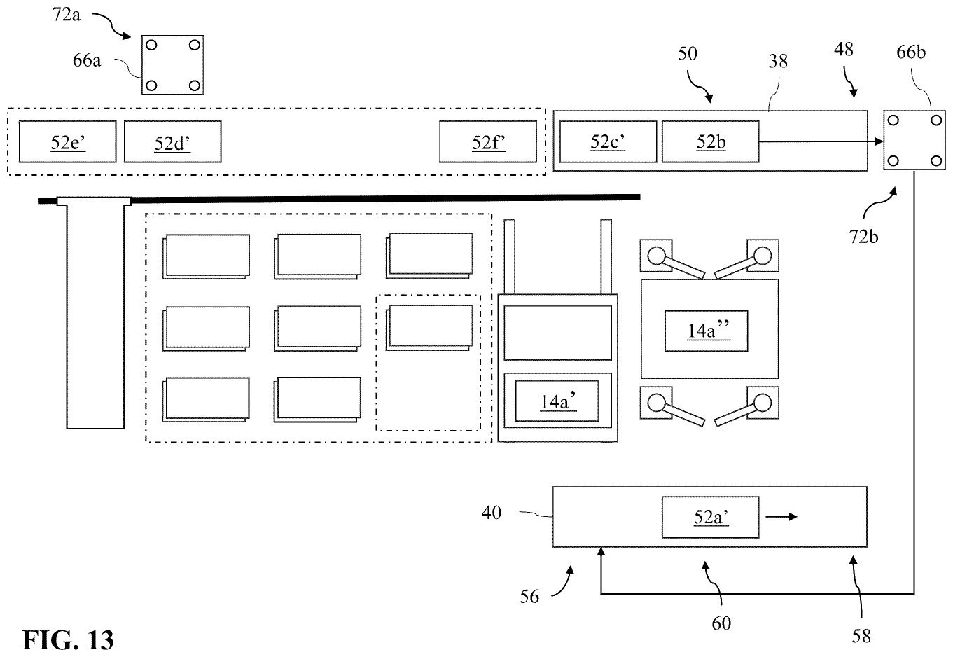

As shown in FIG. 13, the second parts rack 52b is conveyed to the second side 48 of the first indexing conveyor 38 once all of the first form parts are removed from the full second parts rack 52b′. The full third parts rack 52c′ is conveyed to the press section 50 of the first indexing conveyor 38. The second AMR 66b transports the second parts rack 52b to the first side 56 of the second indexing conveyor 40, wherein the full first parts rack 52a′ (fully loaded with second form parts) is conveyed to the second side 58 of the second indexing conveyor 40 and the second parts rack 52b is conveyed to the stamping section 60. The second AMR 66b moves to the third operating position 74 after transporting the second parts rack 52b.

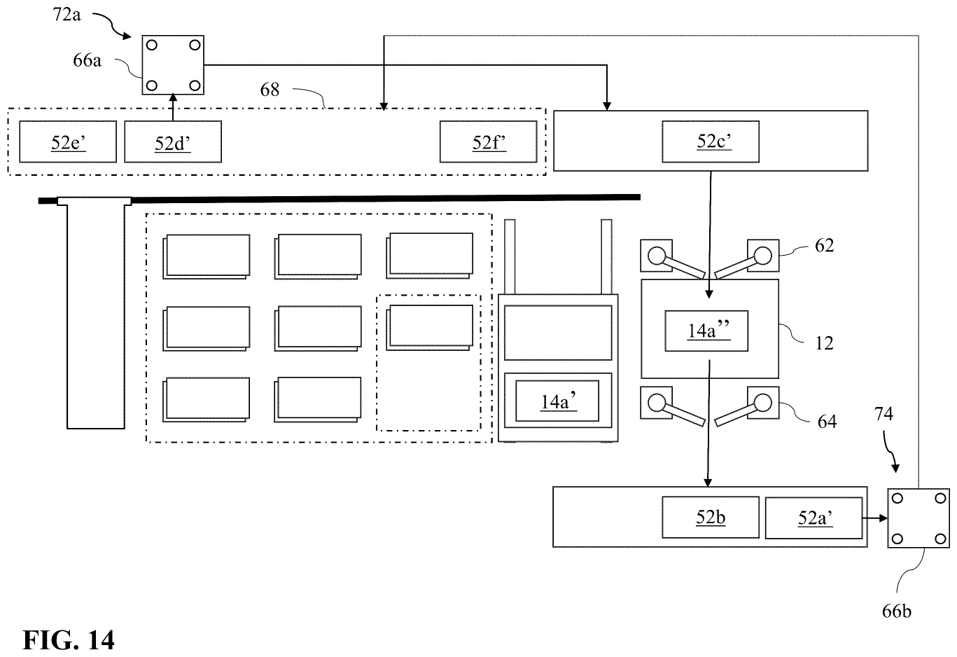

As shown in FIG. 14, the full first parts rack 52a′ with second form parts is transported to the rack loading area 68 by the second AMR 66b. The full fourth parts rack 52d′ with first form parts is transported to the first indexing conveyor 38 by the first AMR 66a. The first robot 62 conveys the first form parts from the full third parts rack 52c′ to the press 12 and the second robot 64 conveys the second form parts created by the press 12 to the second parts rack 52b.

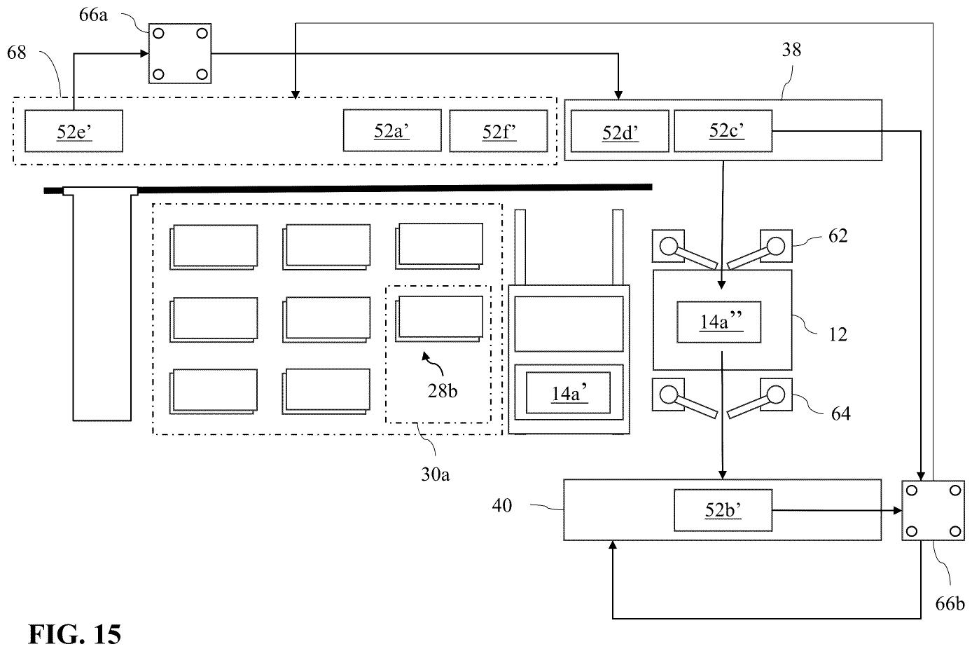

As shown in FIG. 15, the process described above and illustrated in FIGS. 8-14 continues until all first form parts are stamped into second form parts. In other words, the process will continue until the first form parts from the full third parts rack 52c′, full fourth parts rack 52d′, and the full fifth parts rack 52e′ are stamped into second form parts by the press 12 mounted with the second die 14a″. The first AMR 66a will transport the full fifth parts rack 52e′ to the first indexing conveyor 38. The second AMR 66b will transport the full second parts rack 52b′, the full third parts rack 52c′, and the full fourth parts rack 52d′ loaded with second form parts from the second indexing conveyor 40 to the rack loading area 68. The first AMR 66a or the second AMR 66b may transport the empty fifth parts rack 52e from the first indexing conveyor 38 to the second indexing conveyor 40.

As shown in FIG. 16, the first die 14a′ and the second die 14a″ have been transported from the die exchange unit 16 to the die field 26 by the crane 22 and are stacked in the first stack 28a. The third die 14b′ of the first group 30a has been transported from the second stack 28b to the second die change station 20. The third die 14b′ may be used by the press 12 to perform a third die operation and the fourth die 14b″ may be used by the press 12 to perform a fourth die operation. Consequently, the production system 10 may be used, according to the process outlined above and illustrated generally in FIGS. 2-15, may be repeated such that multiple die operations may be performed by the press 12 to create parts in a completed form (e.g., parts that have undergone four die operations). Similarly, the production system 10 may setup and used to produce multiple different parts by attaching the plurality of dies 14 from the plurality of groups 30. For example, production system 10 may interchangeably operate using the plurality of dies 14 from the second group 30b, the third group 30c, the fourth group 30d, or the like, according to the process outlined above.

Using a single press that can be used for multiple die operations and to produce multiple parts significantly reduces the capital investment to establish to production system 10. For example, multiple lines of presses to perform individual die operations for various parts are not required so there is less equipment (presses, racks for individual lines, etc.) and workspace required. In addition, the work-in-process is more efficient. Stamped parts can be stacked during the work-in-process (leading to savings in workspace and the cost for palletizing parts) and the work-in-process is reduced, meaning stamped panels move directly from the “press line” to the “assembly line” until the parts are finished. Moreover, a limited number of racks/pallets are required due to AMRs or AGVs being implemented for optimal automatic rack/pallet transportation. These benefits further enhance the ability of the production system 10 to be used for the low volume production of stamped parts, which otherwise may require a significant capital investment for a press line(s) that may be often be idle. Overall, the production system 10 may be implemented for a low capital investment and may be used for the automated, efficient, and flexible production of a low, medium, or high volume of stamped parts using a single press and a plurality dies. Additionally, the methods and systems described herein allow for on-site assembly of the production system. Due to the reduced amount of equipment necessary and the reduced footprint of the production system compared to traditional production systems, the entire low-volume production system 10 can be delivered and assembled on-site without the need for an extremely large facility.

Referring to FIGS. 2-16, in an embodiment, a method for the automated production of parts includes transporting the first die 14a′ from the die field 26 to the die exchange unit 16 by the crane 22. The first die 14a′ is conveyed from the die exchange unit 16 to the press 12. The first die 14a′ is attached to the press 12. The part or the blank is conveyed from the first indexing conveyor 38 to the press 12 via the first robot 62. The press 12 is operated with the first die 14a′ attached thereto to perform the first die operation to create the first part shape. The first part shape is conveyed from the press 12 to the first rack 52a on the second indexing conveyor 40 via the second robot 64. The second die 14a″ is transported to the die exchange unit 16 from the die field 26 by the crane 22. The first die 14a′ is removed from the press 12 and conveyed to the die exchange unit 16. The second die 14a″ is conveyed from the die exchange unit 16 to the press 12. The second die 14a″ is attached to the press. The first rack 52a′ is transported to the first indexing conveyor 38 via the first automated mobile robot 66a, wherein the first rack 52a′ may first be transported to the rack loading area 68. The sixth rack 52f is transported to the second indexing conveyor 40 via the second automated mobile robot 66b. The first part shape is conveyed from the first rack 52a′ on the first indexing conveyor 38 to the press 12 by the first robot 62. The press 12 is operated with the second die 14a″ attached thereto to perform the second die operation on the first part shape to create the second part shape. The second part shape is conveyed from the press 12 to the second rack 52f on the second indexing conveyor 40 by the second robot 64. The sixth rack 52f is transported from the second indexing conveyor 40 to the rack loading area 68 via the second automated mobile robot 66b. The sixth rack 52f is transported from the rack loading area 68 to the first indexing conveyor 38 via the first automated mobile 66a.

In some embodiments, the method includes transporting the third die 14b′ from the die field 26 to the die exchange unit 16 by the crane 22 and conveying the third die 14b′ from the die exchange unit 16 to the press 12 to perform a third die operation on the second part shape to create a third part shape.

In an embodiment, the press 12 is operated with one of the plurality of dies 14 die attached to the press 12 to perform a die operation to create a part shape (e.g., a first part shape, second part shape, third part shape, or the like), wherein the part shape includes a non- flanged end. A flanged end may refer to an end that has an acute angle (e.g., angled under 90 degrees or folded over on top of the part), whereas a non-flanged end may refer to an end that has an obtuse angle (e.g., angled over 90 degrees or folded away from the part). When part shapes includes a flanged end it can be difficult to stack or arrange the part shapes in a concentrated and/or high volume manner and to unstack or remove the part shapes from a parts rack 52, such that a special parts rack 52 is required. Accordingly, by operating the press 12 to create the part shape with a non-flanged end, the part shapes can be more easily stacked and unstacked, and no special parts racks 52 are required (which reduces the capital and number of parts racks 52 required for operation, transportation, storage, etc.). In some embodiments, a non-flanged end may refer to an end that is angled at 90 degrees if the part shapes can be stacked in a high volume arrangement, or the like.

In some embodiments, the press 12 is operated with one of the plurality of dies 14 die attached to the press 12 to perform a die operation to create a final part shape, wherein the final part shape includes a flanged end. In some embodiments, the press 12 is operated with one of the plurality of dies 14 die attached to the press 12 to perform a die operation to create a final part shape, wherein the final part shape includes a non-flanged end. The final part shape with the non-flanged end may be conveyed or transported to another press line and/or assembly line, wherein the final part shape is then flanged and includes a flanged end. A final part shape may refer to the part shape created by the last die operation performed by the press 12. In other words, no more die operations are performed on the final part shape by the press 12, however, other die operations may be performed on the final part shape by another press.

In an embodiment, the final part shapes are conveyed and loaded onto at least one of the parts racks 52 or another parts rack and transported to another production system (e.g., an assembly line, press line, painting system, etc.). In other words, the production system 10 may not be located adjacent to or within close proximity to the other production system or downstream processes. For example, the production system 10 may be located in a first building and the other production system may be located in a second building, and/or the production system 10 may be located at a first end of a facility and the other production system may be located at a second end of the facility opposite the first end.

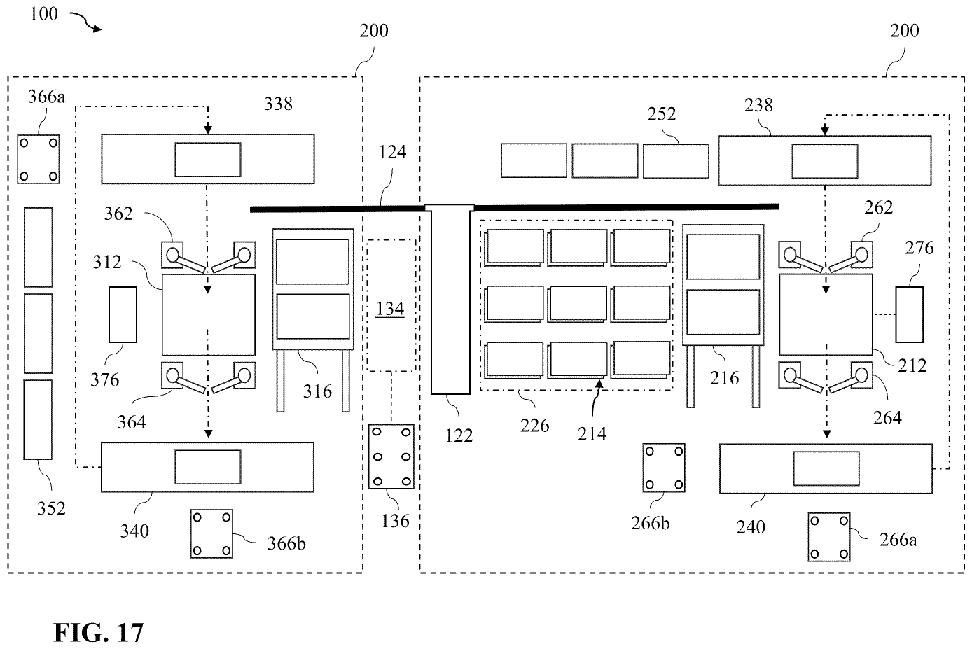

Referring to FIG. 17, a production system 100 may include a first line 200 and a second line 300, according to an embodiment of the present disclosure. The first line 200 may include and operate according to the aspects described above for the production system 10. For example, the first line 200 may include a press 212, a plurality of dies 214, a die exchange unit 216, a die field 226, a first indexing conveyor 238, a second indexing conveyor 240, a plurality of racks 252, a first robot 262, a second robot 264, a first AMR 266a, a second AMR 266b, and a scrap collector 278.

The second line 300 may be positioned at an opposite end of the die field 226 distal to the die exchange unit 216 and may mirror the first line 200. The second line 300 may include a press 312, a plurality of dies 314, a die exchange unit 316, a first indexing conveyor 338, a second indexing conveyor 340, a plurality of racks 352, a first robot 362, a second robot 364, a first AMR 366a, a second AMR 366b, and a scrap collector 378.

In an embodiment, the production system 100 may include a crane 122 configured to move along a rail 124, wherein the rail extends from the die exchange unit 216 of the first line 200 to the die exchange unit 316 of the second line 300. In this way, the crane 122 may be programmed and configured for transporting the plurality of dies 214 from the die field 226 to both die exchange units 216, 316. Accordingly, the plurality of dies 214 may be used by both the press 212 of the first line 200 and the press 312 of the second line 300. The sharing of the plurality of dies 214 and crane 122 allows for the production system 100 to increase production volume of parts without the need for additional material handling equipment. In an embodiment, the production system 100 may include a die maintenance area 134 and a die transfer cart 136 positioned between the first line 200 and the second line 300.

The first line 200 and the second line 300 may operate as outlined above and illustrated by FIGS. 2-16 and produce a follow of stamped parts that flow in a single direction for consistency.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for an automated production of parts, the method comprising:
conveying a part from a first indexing conveyor to a press;
operating the press with a first die attached thereto to perform a first die operation to create a first part shape;
conveying the first part shape from the press to a first rack on a second indexing conveyor;
transporting a second die to a die exchange unit;
removing the first die from the press and conveying the first die to the die exchange unit;
conveying the second die from the die exchange unit to the press;
attaching the second die to the press;
transporting the first rack to the first indexing conveyor via a first automated mobile robot;
transporting a second rack to the second indexing conveyor via a second automated mobile robot;
conveying the first part shape from the first rack on the first indexing conveyor to the press;
operating the press with the second die attached thereto to perform a second die operation on the first part shape to create a second part shape; and
conveying the second part shape from the press to the second rack on the second indexing conveyor.

2. The method of claim 1 further comprising:
transporting the first die from a die field to the die exchange unit by a crane;
conveying the first die from the die exchange unit to the press;
attaching the first die to the press; and
wherein transporting the second die to the die exchange unit includes transporting the second die from the die field by the crane.

3. The method of claim 1 wherein:
conveying the part from the first indexing conveyor to the press and conveying the first part shape from the first rack on the first indexing conveyor to the press include a first robot; and
conveying the first part shape from the press to the first rack on the second indexing conveyor and conveying the second part shape from the press to the second rack on the second indexing conveyor include a second robot.

4. The method of claim 1 wherein the second part shape includes a non-flanged end.

5. The method of claim 1 further comprising:
transporting a third die from a die field to the die exchange unit by a crane; and
conveying the third die from the die exchange unit to the press to perform a third die operation on the second part shape to create a third part shape.

6. The method of claim 1 further comprising:
transporting the second rack from the second indexing conveyor to a rack loading area via the second automated mobile robot; and
transporting the second rack from the rack loading area to the first indexing conveyor via the first automated mobile.

7. A low-volume production system for an automated production of parts comprising:
a plurality of racks for holding parts;
a plurality of dies configured to shape the parts;
a press for performing a die operation on the parts, wherein the press is configured to be interchangeably mounted with the plurality of dies;
a die exchange unit adjacent the press and configured for housing at least one of the plurality of dies, and wherein the die exchange unit is configured to convey the at least one of the plurality of dies to the press;
a crane mounted to a rail and configured to translate along the rail and transport the plurality of dies to and from the die exchange unit;
a first indexing conveyor configured to convey the plurality of racks along the first indexing conveyor;
a second indexing conveyor configured to convey the plurality of rack along the second indexing conveyor;
a first robot configured to convey the parts from the plurality of racks on the first indexing conveyor to the press;
a second robot configured to convey the parts from the press to the plurality of racks on the second indexing conveyor;
a first automated mobile robot programmed to:
transport the plurality of racks loaded with parts by the second robot from the second indexing conveyor to a rack loading area, and
transport the plurality of racks loaded with parts from the rack loading area to the first indexing conveyor; and
a second automated mobile robot programmed to:
transport the plurality of racks without parts to the second indexing conveyor, and
transport the plurality of racks loaded with parts by the second robot from the second indexing conveyor to the rack loading area.

8. The production system of claim 7 wherein the die exchange unit includes a first die change station and a second die change station each configured to house one of the plurality of dies;
wherein the die exchange unit is configured to translate vertically to align the first die change station or the second die change station with the press; and
wherein the die exchange unit is configured to convey the one of the plurality of dies housed in the first die change station or the second die change station to the press.

9. The production system of claim 7 wherein:
the plurality of dies are arranged to form a plurality of stacks in a die field, wherein each of the plurality of stacks include at least two of the plurality of dies;
the plurality of dies form a plurality of groups for performing a series of die operations to produce a particular part; and
the crane is configured to transport the plurality of dies between the die field and the die exchange unit.

10. The production system of claim 8 wherein the crane is configured to transport the plurality of dies to and from the first die change station and the second die change station.

11. The production system of claim 7 wherein the crane is mounted to a rail and the rail is connected to a floor.

12. The production system of claim 7 wherein the press is located between the first indexing
conveyor and the second indexing conveyor;
wherein the first robot is positioned between the first indexing conveyor and the press; and
wherein the second robot is positioned between the press and the second indexing conveyor.

13. The production system of claim 7 further comprising a scrap collector configured to collect pieces of scrap created by the press after performing the die operation on the part.

14. The production system of claim 7 further comprising a die transfer cart configured to convey the plurality of dies from a die field to a die maintenance area.

15. The production system of claim 7 wherein the second automated mobile robot is programmed and configured to transport the plurality of racks without parts from a rack storage area or the first indexing conveyor to the second indexing conveyor;
wherein at least one of the plurality of racks is configured for holding blank panels; and
wherein the second automated mobile robot is programmed and configured to transport the at least one of the plurality of racks for holding blank panels from the first indexing conveyor to a storage location after the first robot has conveyed all the blank panels to the press.

16. The production system of claim 7 wherein the first indexing conveyor includes a first side, a second side opposite the first side, and a press section between the first side and the second side;
wherein the first robot is configured to convey the parts from the plurality of racks on the first indexing conveyor when the plurality of racks on the first indexing conveyor are positioned in the press section;
wherein the second indexing conveyor includes a first side, a second side opposite the first side, and a stamping section between the first side and the second side; and
wherein the second robot is configured to convey the parts from the press to the plurality of racks on the second indexing conveyor when the plurality of racks on the second indexing conveyor are positioned in the stamping section.

17. The production system of claim 16 wherein the first indexing conveyor is configured to convey the plurality of racks from the first side of the first indexing conveyor to the press section when the plurality of racks are loaded with the parts, and from the press section to the second side of the first indexing conveyor when the plurality of racks are empty; and
wherein the second indexing conveyor is configured to convey the plurality of racks from the first side of the second indexing conveyor to the stamping section when the plurality of racks are empty, and from the stamping section to the second side of the second indexing conveyor when the plurality of racks are loaded with the parts.

18. A production system for an automated production of parts comprising:
a plurality of dies arranged in a die field and configured to shape parts;
a first production line and a second production line, wherein the first production line and the second production line both include:
a plurality of racks for holding the parts,
a press for performing a die operation on the parts, wherein the press is configured to be interchangeably mounted with the plurality of dies,
a die exchange unit adjacent the press and configured for housing at least one of the plurality of dies, and wherein the die exchange unit is configured to convey the at least one of the plurality of dies to the press,
a first indexing conveyor configured to convey the plurality of racks along the first indexing conveyor,
a second indexing conveyor configured to convey the plurality of rack along the second indexing conveyor,
a first robot configured to convey the parts from the plurality of racks on the first indexing conveyor to the press,
a second robot configured to convey the parts from the press to the plurality of racks on the second indexing conveyor,
a first automated mobile robot programmed and configured to transport the plurality of racks loaded with parts from the second indexing conveyor to a respective rack loading area of the first or second production line, and wherein the first automated mobile robot is programmed and configured to transport the plurality of racks loaded with parts from the respective rack loading area of the first or second production line to the first indexing conveyor, and
a second automated mobile robot programmed and configured to transport the plurality of rack without parts to the second indexing conveyor, and wherein the second automated mobile robot is programmed and configured to transport the plurality of racks loaded with parts by the second robot from the second indexing conveyor to the respective rack loading area of the first or second production line; and
a crane configured to transport the plurality of dies between the die field and the die exchange units of the first production line and the second production line.

19. The production system of claim 18 further comprising a die transfer cart configured to convey the plurality of dies from a die field to a die maintenance area.

20. The production system of claim 18 wherein the first production line and the second production line operate independent of one another.
